(19) United States
(12) Patent Application Publication
(10) Pub. No.: US 2017/0062924 A1
(43) Pub. Date: Mar. 2, 2017

(54) PLANAR BEAM STEERABLE ANTENNA

(71) Applicant: Soonchunhyang University Industry Academy Cooperation Foundation, Asan-si (KR)

(72) Inventors: Seok Jae LEE, Uiwang-si (KR); Sang-Min HAN, Suwon-si (KR)

(21) Appl. No.: 15/068,610

(22) Filed: Mar. 13, 2016

(30) Foreign Application Priority Data
Aug. 24, 2015 (KR) 10-2015-0119120

(51) Int. Cl. H01Q 3/24; H01Q 19/28

(52) U.S. Cl. CPC H01Q 3/247; H01Q 19/28

(57) ABSTRACT

A planar beam steerable antenna may comprise a base substrate, a signal supply via hole passing through the base substrate, an active antenna disposed on a first surface of the base substrate, the active antenna including a horizontal dipole antenna having two unit antennas disposed apart from each other and a vertical dipole antenna having two unit antennas disposed apart from each other, a switching element disposed on a second surface of the base substrate and performing switching to provide a signal to one of the horizontal dipole antenna and the vertical dipole antenna, a signal supply line electrically connecting the active antenna with the switching element via the signal supply via hole, and a plurality of passive parasitic antennas disposed on the first surface of the base substrate apart from the active antenna.

### CROSS-REFERENCE TO RELATED APPLICATIONS

This patent application claims priority wider 35 U.S.C. §119 to Korean Patent Application No. 10-2015-0119120, filed Aug. 24, 2015, in the Korean Intellectual Property Office, the disclosure of which is incorporated by reference herein in its entirety.

### TECHNICAL FIELD

Embodiments of the present disclosure concern planar beam steerable antennas and more specifically, to planar steerable planar antennas that may actively adjust beams using an electrical switching circuit.

### DISCUSSION OF RELATED ART

An antenna array is a set of individual antennas used for transmitting and/or receiving radio waves, connected together in such a way that their individual currents are in a specified amplitude and phase relationship. The interactions of the different phases enhance the signal in one desired direction at the expense of other directions. This allows the array to act as a single antenna, generally with improved directional characteristics (thus higher antenna gain) than would be obtained from the individual elements. The electrically steerable parasitic array radiator (ESPAR) antenna is in research, which uses a single RF chain, benefiting a compact design, cost savings, and reduced power consumption.

The conventional ESPAR antenna has a three-dimensional structure with an active element and parasitic elements and requires additional bias circuits. Thus, the ESPAR antenna is difficult to design and apply to portable devices and has limitations in enhancing the beam directivity.

### SUMMARY

According to an embodiment of the present disclosure, a planar beam steerable antenna may comprise a base substrate having a plane in an X direction and a Y direction and a depth in a Z direction, a signal supply via hole passing through the base substrate in the Z direction, an active antenna disposed on a first surface of the base substrate, the active antenna including a horizontal dipole antenna having two unit antennas disposed apart from each other in the X direction and a vertical dipole antenna having two unit antennas disposed apart from each other in the Y direction, wherein the horizontal dipole antenna is disposed to cross the vertical dipole antenna to be substantially perpendicular with the vertical dipole antenna, a switching element disposed on a second surface of the base substrate and performing switching to provide a signal to one of the horizontal dipole antenna and the vertical dipole antenna, a signal supply line electrically connecting the active antenna with the switching element via the signal supply via hole, and a plurality of passive parasitic antennas disposed on tile first surface of the base substrate apart from the active antenna to radiate a coupling signal of the active antenna.

The horizontal dipole-antenna may include a first horizontal unit antenna disposed in the X direction to excite a first signal and a second horizontal unit antenna disposed apart from the first horizontal unit antenna in the X direction to excite a second signal. The vertical dipole antenna may include a first vertical unit antenna disposed in the Y direction to excite a first signal and a second vertical unit antenna disposed apart from the first vertical unit antenna in the Y direction to excite a second signal. The first vertical unit antenna may be disposed at a first side of a space between the first horizontal unit antenna and the second horizontal unit antenna to be perpendicular with the first horizontal unit antenna and the second horizontal unit antenna. The second vertical unit antenna may be disposed at a second side of the space to be perpendicular with the first horizontal unit antenna and the second horizontal unit antenna. The second side may be an opposite side of the first side.

The plurality of passive parasitic antennas may include a plurality of horizontal passive parasitic antennas disposed in the X direction on the first surface of the base substrate apart from the horizontal dipole antenna and parallel with the horizontal dipole antenna and a plurality of vertical passive parasitic antennas disposed in the Y direction on the first surface of the base substrate apart from the vertical dipole antenna and parallel with the vertical dipole antenna.

Each of the horizontal passive parasitic antennas may include a first variable capacitor.

The planar beam steerable antenna may further comprise a first via hole passing through the base substrate in the Z direction, a first capacitance adjusting element disposed on the second surface of the base substrate to vary a capacitance of the first variable capacitor, and a first signal supply line electrically connecting the first variable capacitor with the first capacitance adjusting element via the first via hole.

Each of the vertical passive parasitic antennas may include a second variable capacitor.

The planar beam steerable antenna may comprise a second via hole passing through the base substrate in the Z direction, a second capacitance adjusting element disposed on the second surface of the base substrate to vary a capacitance of the second variable capacitor, and a second signal supply line electrically connecting the second variable capacitor with the second capacitance adjusting element via the second via hole.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings, wherein:

FIG. 1 is a plan view illustrating a planar beam steerable antenna using an electrical switching circuit according to an embodiment of the present disclosure;

FIG. 2 is a cross-sectional view illustrating an example in which a switching element is formed on the bottom of a base substrate in a planar beam steerable antenna according to an embodiment of the present disclosure;

FIG. 3 is a cross-sectional view illustrating an example in which a switching element is formed on a switching substrate formed on the bottom of a base substrate in a planar beam steerable antenna according to an embodiment of the present disclosure;

FIG. 4 is a plan view illustrating an example in which a horizontal dipole antenna is operated by switching in a planar beam steerable antenna according to an embodiment of the present disclosure;

FIG. 5 is a plan view illustrating an example in which a vertical dipole antenna is operated by switching in a planar beam steerable antenna according to an embodiment of the present disclosure;

FIG. 6 is a plan view illustrating a planar beam steerable antenna including passive parasitic antennas according to an embodiment of the present disclosure;

FIG. 7 is a plan view illustrating an example in which a horizontal dipole antenna and horizontal passive parasitic antennas are operated by switching in a planar beam steerable antenna having passive parasitic antennas according to an embodiment of the present disclosure;

FIG. 8 is a plan view illustrating an example in which a vertical dipole antenna and vertical passive parasitic antennas are operated by switching in a planar beam steerable antenna having passive parasitic antennas -accosting to an embodiment of the present disclosure;

FIG. 9 is a cross-sectional view illustrating a planar beam steerable antenna having horizontal passive parasitic antennas and a first capacitance adjusting element according to an embodiment of the present disclosure; and

FIG. 10 is a cross-sectional view illustrating a planar beam steerable antenna having vertical passive parasitic antennas and a second capacitance adjusting element according to an embodiment of the present disclosure.

### DETAILED DESCRIPTION OF EXEMPLARY EMBODIMENTS

Hereinafter, exemplary embodiments of the inventive concept will be described in detail with reference to the accompanying drawings. The inventive concept, however, may be modified in various different ways, and should not be construed as limited to the embodiments set forth herein. As used herein, the singular forms “a,” “an,” and “the” are intended to include the plural forms as well, unless the context clearly indicates otherwise. It will be understood that when an element or layer is referred to as being “on,” “connected to,” “coupled to,” or “adjacent to” another element or layer, it can be directly on, connected, coupled, or adjacent to the other element or layer, or intervening elements or layers may be present.

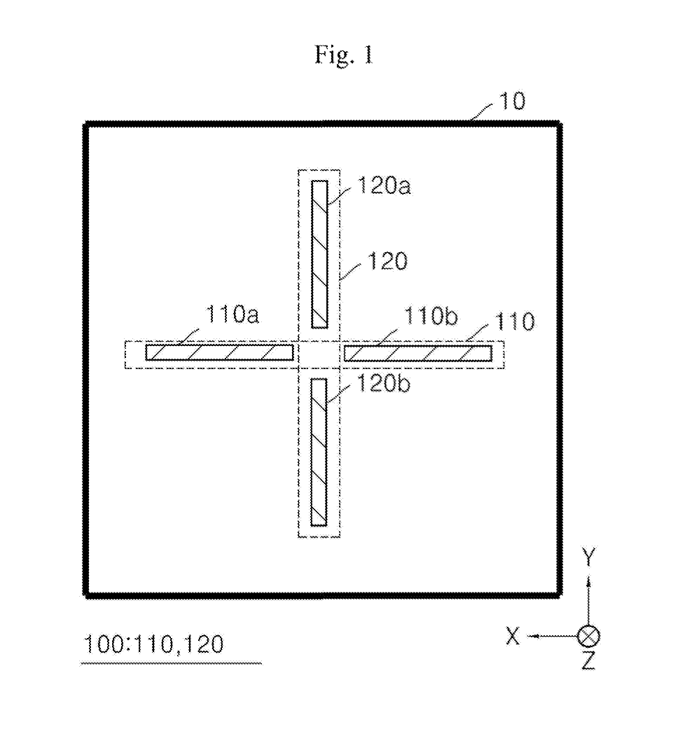

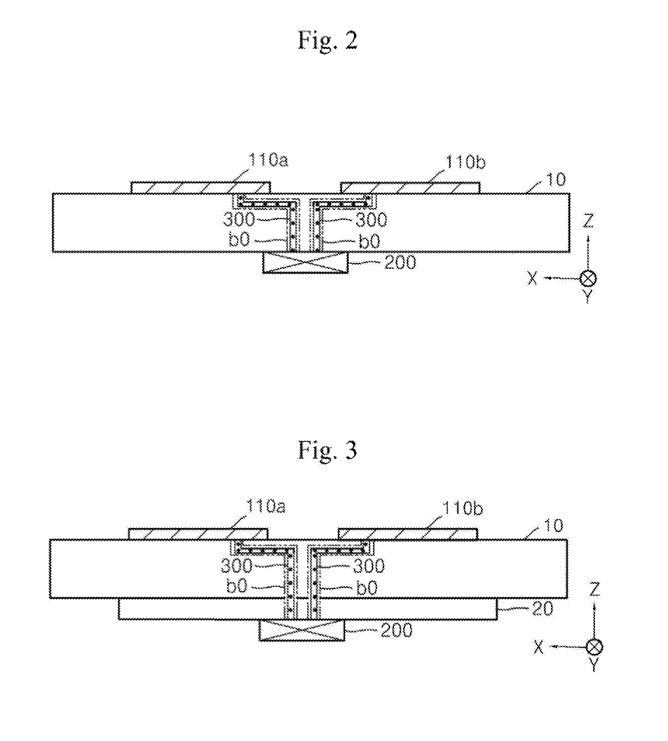

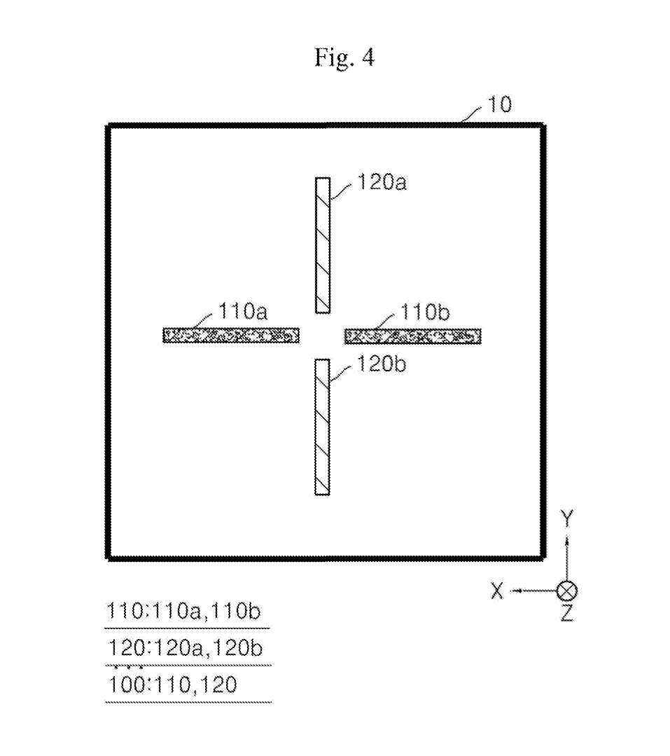

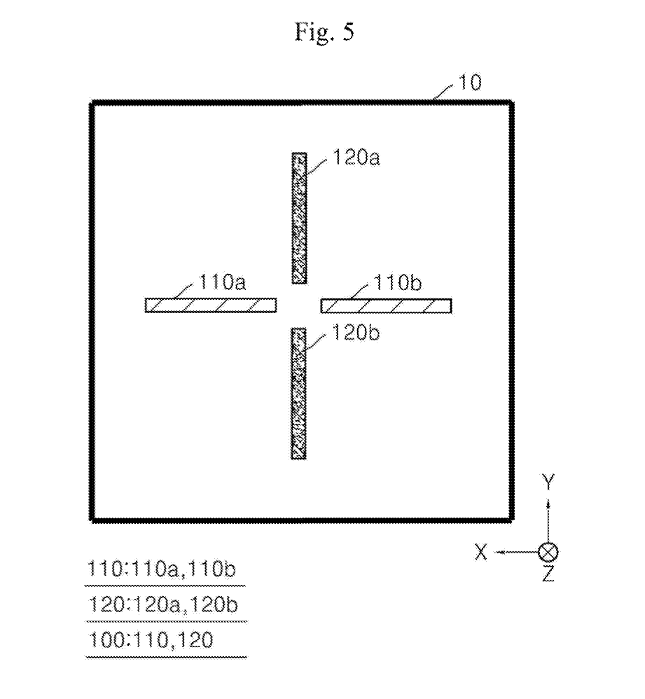

FIG. 1 is a plan view illustrating a planar beam steerable antenna using an electrical switching circuit according to an embodiment of the present disclosure. FIG. 2 is a cross-sectional view illustrating an example in which a switching element is formed on the bottom of a base substrate in a planar beam steerable antenna according to an embodiment of the present disclosure. FIG. 3 is a cross-sectional view illustrating an example in which a switching element is formed on a switching substrate formed on the bottom of a base substrate in a planar beam steerable antenna according to an embodiment of the present disclosure. FIG. 4 is apian view illustrating an example in which a horizontal dipole antenna is operated by switching in a planar beam steerable antenna according to an embodiment of the present disclosure. FIG. 5 is a plan view illustrating an example in which a vertical dipole antenna is operated by switching in a planar beam steerable antenna according to an embodiment of the present disclosure;

According to an embodiment of the present disclosure, an electrically steerable parasitic array radiator antenna having spatial limitations is designed in a planar structure, allowing the antenna enhanced directivity through a Yagi-Uda array antenna scheme.

According to an embodiment of the present disclosure, active antennas 100 shaped as a cross are positioned at a center thereof. The active antennas 100 and parasitic element antennas (also simply referred to as parasitic elements) may be rendered to operate in a desired direction by an electrical switching circuit, thereby enabling the active adjustment of beams from the antennas.

To that end, according to an embodiment of the present disclosure, a planar beam steerable antenna may include a base substrate 10, signal supply lines 30 for active antennas, signal supply via holes b0, an active antenna 100, and a switching element 200.

The base substrate 10 includes a plane in X and Y directions and a depth in a Z direction. The base substrate 10 may adopt various types of substrates, including, e.g., a dielectric substrate, but not limited thereto. The base substrate 10 has a horizontal plane in the X and Y directions. As used herein, the X direction and the Y direction may also be interchangeably used with a horizontal direction and vertical direction, respectively.

The signal supply via holes b0 may pass through the base substrate 10 in the Z direction. The Z direction may be substantially perpendicular to the X or Y direction.

The active antenna 100 may include two dipole antennas disposed on the base substrate 10 to be perpendicular with each other. The active antenna 100 may include a horizontal dipole antenna 110 having two unit antennas spaced apart from each other in the X direction and a vertical dipole antenna 120 having two unit antennas spaced apart from each other in the Y direction. The horizontal dipole antenna 110 and the vertical dipole antenna 120 may cross each other perpendicularly with each other. The active antenna 100 is disposed on the base substrate 10, e.g., the top of the base substrate 10.

A dipole antenna may be an antenna having two unit-antennas respectively connected with two opposite ends of a power supply line to communicate radio waves. When the dipole antenna has a direction in which the unit antennas are connected is perpendicular with the Earth's surface, the dipole antenna may be the vertical dipole antenna 120 that generates vertically polarized waves with electric fields oriented vertically. By contrast, when the unit antennas are connected in a direction parallel with the ground, the dipole antenna may be the horizontal dipole antenna 110 that generates horizontally polarized waves whose electric fields are directed horizontally.

According to an embodiment of the present disclosure, the horizontal dipole antenna 110 and the vertical dipole antenna 120 are arranged to cross each other to generate horizontally polarized waves or vertically polarized waves by switching.

Accordingly, according to an embodiment, of the present disclosure, the horizontal dipole antenna of the active antenna 100 includes a first horizontal unit antenna 110a disposed in the X direction to excite a first signal (e.g., ‘+’ a signal) and a second horizontal unit antenna 110b disposed apart from the first horizontal unit antenna 110a in the X direction to excite a second signal (e.g., ‘−’ a signal).

In a similar way, the vertical dipole antenna 120 of the active antenna 100 includes a first vertical unit antenna 120a disposed in the Y direction to excite a first signal (e.g., ‘+’ a signal) and a second vertical unit antenna 120b disposed apart from the first vertical unit antenna 120a in the Y direction to excite a second signal (e.g., a ‘−’ signal).

The first vertical unit antenna 120a may be disposed at a first side of a space between the first horizontal unit antenna 110a and the second horizontal unit antenna 110b to be perpendicular with the first horizontal unit antenna 110a and the second horizontal unit antenna 110b, and the second vertical unit antenna 120b may be disposed at a second side of the space to be perpendicular with fee first horizontal unit antenna 110a and the second horizontal unit antenna 110b, wherein the second side may be an opposite side of the first side.

When a signal is provided through switching to the horizontal dipole antenna 110 including the first horizontal unit antenna 110a and the second horizontal unit antenna 110b, horizontally polarized waves are radiated through the horizontal dipole antenna 110 as illustrated in FIG. 4. At this time, no signal is supplied to the vertical dipole antenna 120 including the first vertical unit antenna 120a and the second vertical unit antenna 120b.

In a similar manner, when a signal is provided through switching to the vertical dipole antenna 120 including the first vertical unit antenna 120a and the second vertical unit antenna 120b, vertically polarized waves are radiated through the vertical dipole antenna 120 as illustrated in FIG. 5. At this time, no signal is supplied to the horizontal dipole antenna 110 including the first horizontal unit antenna 110a and the second horizontal unit antenna 110b.

The switching for radiating the horizontally polarized waves or vertically polarized waves may be performed through a separate switching element 200. As illustrated in FIG. 2, the switching element 200 may be disposed on, e.g., the bottom of the base substrate 10 to switch the supply of a signal to the horizontal dipole antenna 110 or the vertical dipole antenna 120.

The signal supply lines 300 electrically connect the active antenna 100 with the switching element 200 via the signal supply via holes b0. Accordingly, a signal may be supplied to the horizontal dipole antenna 110 or the vertical dipole antenna 120 through the signal supply lines 300 in the signal supply via holes b0 by the switching of the switching element 200.

Referring to FIG. 2, according to an embodiment of the present disclosure, the switching element 200 may be directly provided on the bottom of the base substrate 10. Alternatively, as illustrated in FIG. 3, a separate switching substrate 20 may be provided on the bottom of the base substrate 10, and the switching element 200 may be provided on the bottom of the switching substrate 20. For example, the separate switching substrate 20 may be provided between the base substrate 10 and the switching element 200. In this case, the signal supply via holes b0 may also pass through the switching substrate 20 to transfer a signal from the switching element 200 to the active antenna 100 on the top of the base substrate 10.

According to an embodiment of the present disclosure, the active antenna 100 may be designed or formed to be shaped substantially as a cross, and the active antenna 100 may perform a predetermined antenna operation (e.g., selective radiation of horizontally polarized waves or vertically polarized waves) by an electrical switching circuit (e.g., the switching element 200).

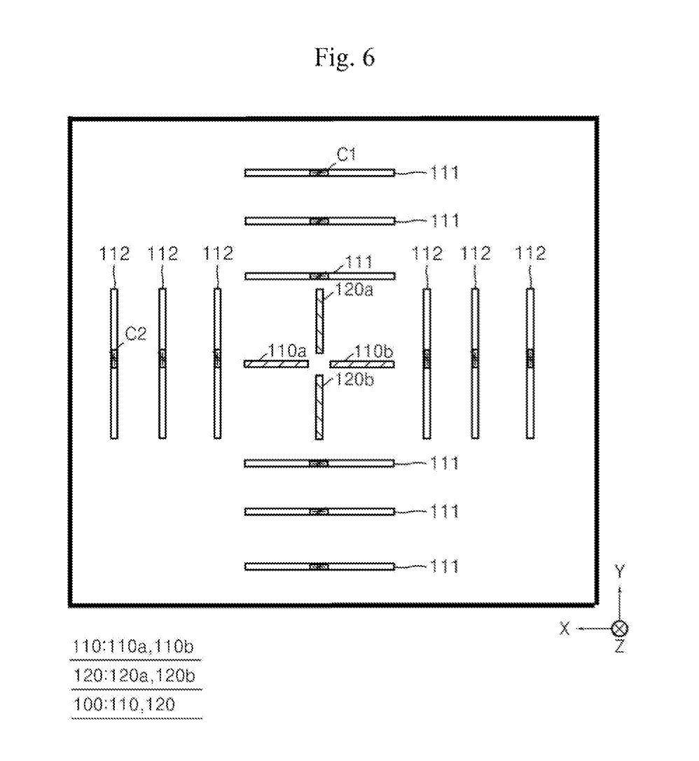

When a signal is selectively radiated through one of the horizontal dipole antenna 100 or the vertical dipole antenna 120 by switching, separate parasitic antennas 111 and 112 may be provided to allow the signal enhanced directivity. An example thereof is described below with reference to FIGS. 6 to 10.

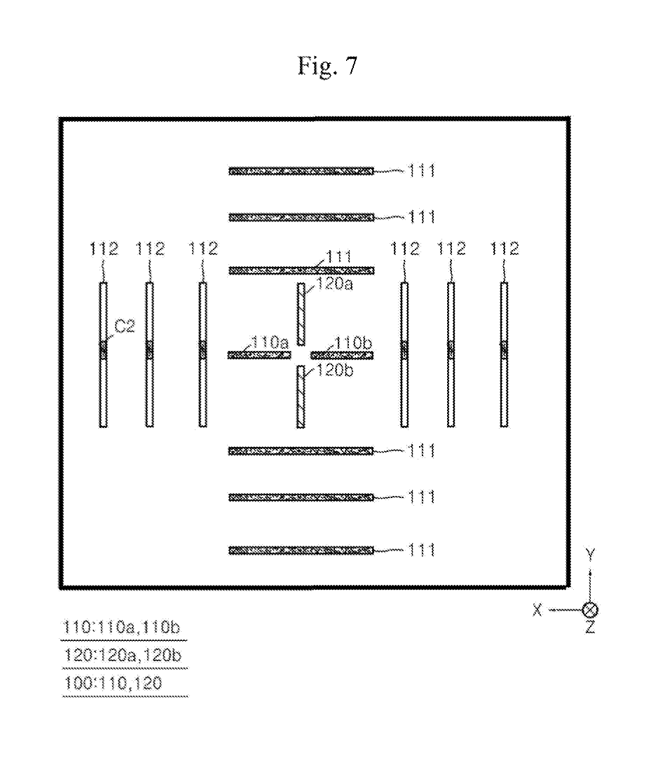

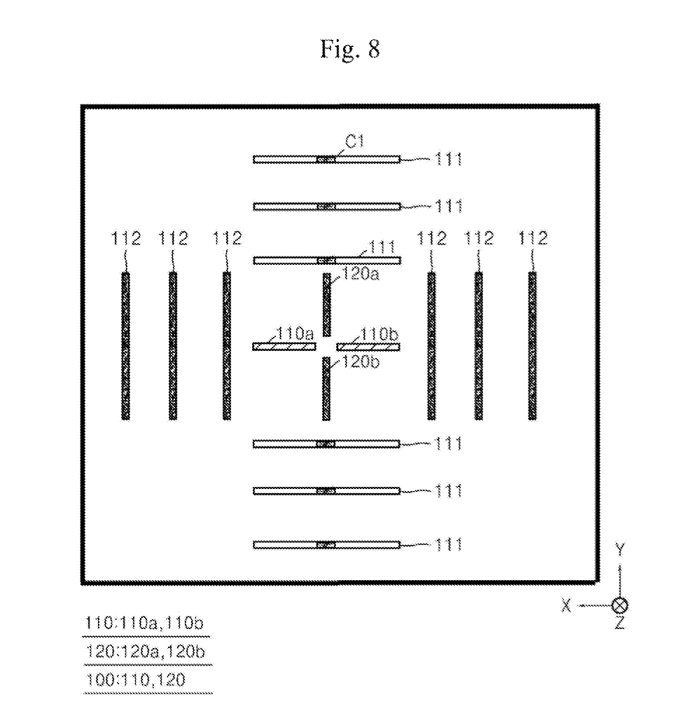

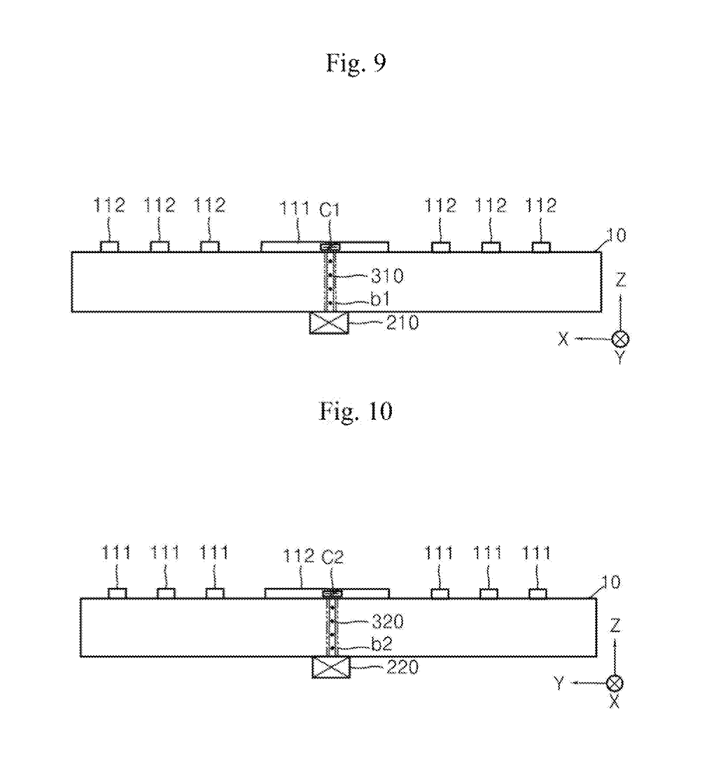

FIG. 6 is a plan view illustrating a planar beam steerable antenna including passive parasitic antennas according to an embodiment of the present disclosure. FIG. 7 is a plan view illustrating an example in which a horizontal dipole antenna and horizontal passive parasitic antennas are operated by switching in a planar beam steerable antenna having passive parasitic antennas according to an embodiment of the present disclosure. FIG. 8 is a plan view illustrating an example in which a vertical dipole antenna and vertical passive parasitic antennas are operated by switching in a planar beam steerable antenna having passive parasitic antennas according to an embodiment of the present disclosure. FIG. 9 is a cross-sectional view illustrating a planar beam steerable antenna having horizontal passive parasitic antennas and a first capacitance adjusting element according to an embodiment of the present disclosure. FIG. 10 is a cross-sectional view illustrating a planar beam steerable antenna having vertical passive parasitic antennas and a second capacitance adjusting element according to an embodiment of the present disclosure.

A plurality of passive parasitic antennas 111 and 112 may be disposed apart from the active antenna 100 on the top of the base substrate 10 to radiate coupling signals that are coupled with signals radiated from the active antenna 100.

The passive parasitic antennas 111 and 112 may have various arrays or arrangements. According to an embodiment of the present disclosure, the passive parasitic antennas 111 and 112 may include a plurality of horizontal passive parasitic antennas 111 arranged, in the X direction, apart from the horizontal dipole antenna 110 and parallel with the horizontal dipole antenna 110 on the top of the base substrate 10 and a plurality of vertical passive parasitic antennas 112 arranged, in the Y direction, apart from the vertical dipole antenna 120 and parallel with the vertical dipole antenna 120 on the top of the base substrate 10.

For example, when a horizontally polarized wave is generated from the horizontal dipole antenna 110 by switching as illustrated in FIG. 7, a polarized signal may be radiated from the horizontal passive parasitic antennas 111 by coupling. Likewise, when a vertically polarized wave is generated from the vertical dipole antenna 120 by switching as illustrated in FIG. 8, a parasitic signal may be radiated from the vertical passive parasitic antennas 112 by coupling.

Among the horizontal passive parasitic antennas 111 operated as the horizontal dipole antenna 110 is operated by switching, the outermost passive parasitic antenna in the direction of the signal beam may be operated as a director, and the outermost passive parasitic antenna on an opposite side thereof may be operated as a reflector, leading to enhanced directivity. Likewise, among the vertical passive parasitic antennas 112 operated as the vertical dipole antenna 120 is operated by switching, the outermost passive parasitic antenna in the direction of the signal beam may be operated as a director, and the outermost passive parasitic antenna on an opposite side thereof may be operated as a reflector, leading to enhanced directivity.

Each of the passive parasitic antennas 111 and 112 may have a variable capacitor for adjusting the reactance of the antenna. The reactance of each antenna may be adjusted by adjusting the capacitance.

For example, each horizontal passive parasitic antenna 111 may include a first variable capacitor C1 whose capacitance may be adjusted or varied. For adjusting the capacitance of the first variable capacitor C1, there may be provided a first via hole b1 passing through the base substrate 10 in the Z direction, a first capacitance adjusting element 210 disposed on the bottom of the base substrate 30 to vary the capacitance of the first variable capacitor C1, and a first signal supply line 310 for a parasitic antenna to electrically connect the first variable capacitor C1 with the first capacitance adjusting element 210 via the first via hole b1 as illustrated in FIG. 9.

Each horizontal passive parasitic antenna 112 may include a second variable capacitor C2 whose capacitance may be adjusted or varied. For adjusting the capacitance of the second variable capacitor C2, there may be provided a second via hole b2 passing through the base substrate 10 in the Z direction, a second capacitance adjusting element 220 disposed on the bottom of the base substrate 10 to vary the capacitance of the second variable capacitor C2, and a second signal supply line 320 for a parasitic antenna to electrically connect the second variable capacitor C2 with the second capacitance adjusting element 220 via the second via hole b2 as illustrated in FIG. 10.

While the inventive concept: has been shown and described with reference to exemplary embodiments thereof it will be apparent to those of ordinary skill in the art that various changes in form and detail may be made thereto without departing from the spirit and scope of the inventive concept as defined by the following claims.

1. A planar beam steerable antenna, comprising:
a base substrate having a plane in an X direction and a Y direction and a depth in a Z direction:
a signal-supply via hole passing through the base substrate m the Z direction;
an active antenna disposed on a first surface of the base substrate, the active antenna including a horizontal dipole antenna having two unit antennas disposed apart from-each other in the X direction and a vertical dipole antenna having two unit antennas disposed apart from each other in the Y direction, wherein the horizontal dipole antenna is disposed to cross the vertical dipole antenna to be substantially perpendicular with the vertical dipole antenna;
a switching element disposed on a second surface of the base substrate and performing switching to provide a signal to one of the horizontal dipole antenna and the vertical dipole antenna;
a signal supply line electrically connecting the active antenna with the switching element via the signal supply via hole; and
a plurality of passive parasitic antennas disposed on the first surface of the base substrate apart from the active antenna, wherein the horizontal dipole antenna includes a first horizontal unit antenna disposed in the X direction to excite a first signal and a second horizontal unit antenna disposed apart from the first horizontal unit antenna in the X direction to excite a second signal, wherein the vertical dipole antenna includes a first vertical unit antenna disposed in the Y direction to excite a first signal and a second vertical unit antenna disposed apart from the first vertical unit antenna in the Y direction to excite a second signal, wherein the first vertical unit antenna is disposed at a first side of a space between the first horizontal unit antenna and the second horizontal unit antenna to be perpendicular with the first horizontal unit antenna and the second horizontal unit antenna, and the second vertical unit antenna is disposed at a second side of the space to be perpendicular with the first horizontal unit antenna and the second horizontal unit antenna, and wherein the second side may be an opposite side of the first side, and wherein the plurality of passive parasitic antennas include a plurality of horizontal passive parasitic antennas disposed in the X direction on the first surface of the base substrate apart from the horizontal dipole antenna and parallel with the horizontal dipole antenna and a plurality of vertical passive parasitic antennas disposed in the Y direction on the first surface of the base substrate apart from the vertical dipole antenna and parallel with the vertical dipole antenna.

2.-3. (canceled)

4. The planar beam steerable antenna of claim 1, wherein each of the horizontal passive parasitic antennas includes a first variable capacitor.

5. The planar beam steerable antenna of claim 4, further comprising:
a first via hole passing through the base substrate in the Z direction;
a first capacitance adjusting element disposed on the second surface of the base substrate to vary a capacitance of the first variable capacitor; and
a first signal supply line electrically connecting the first variable capacitor with the first capacitance adjusting element via the first via hole.

6. The planar beam steerable antenna of claim 1, wherein each of the vertical passive parasitic antennas includes a second variable capacitor.

7. The planar beam steerable antenna of claim 6, further comprising;
a second via hole passing through the base substrate in the Z direction;
a second capacitance adjusting element disposed on the second surface of the base substrate to vary a capacitance of the second variable capacitor; and
a second signal supply line electrically connecting the second variable capacitor with the second capacitance adjusting element via the second via hole.
